(19) United States
(12) Patent Application Publication
(10) Pub. No.: US 2006/0218626 A1
(43) Pub. Date: Sep. 28, 2006

(54) Patient identification and information protection system and method

(75) Inventor: Rolf Goehler, Schaumburg, IL (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: Edwards Systems Technology, Inc.

(21) Appl. No.: 11/086,291

(22) Filed: Mar. 23, 2005

(51) Int. Cl. H04L 9/32

(52) U.S. Cl. 726/5

(57) ABSTRACT

A personnel identity protection mechanism and method is provided which utilizes a pseudo-name that is used in conjunction with RFID or RFID-like tags. By correlating the location of the tag wearer to equipment or professionals attending to the tag wear, identity and/or private information relating to the tag wearer can be controlled on a need-to-know basis. Concomitantly, access to the tag wearer's identity and/or private information by attending professionals, wearing a non-pseudo-name RFID or RFID-like tag, can be automatically enabled or filtered by correlating the non-pseudo-name bearing tags' proximity to the accessing system. By use of such a pseudo-name having restricted access capabilities with a RFID or RFID-like tag system, patients or institutionalized persons can be assured of a higher degree of security with respect to their private or medical information.

### FIELD OF THE INVENTION

The present invention relates generally to securing the identity and information relating to individuals. More particularly, the present invention relates to systems and methods for preserving privacy rights in an institutional environment.

### BACKGROUND OF THE INVENTION

Institutional and medical service providers such as hospitals, clinics, doctor offices, etc. have been charged under the U.S. Health Insurance Portability and Accountability Act (HIPAA) regulations to protect a patient's privacy right. This requirement can more easily be managed when the access to patient's information can be limited to only those who have a need to know. Additionally, the patient's identity must also be protected along with the associated medical treatments. Hospitals and clinics have increasingly removed the patient's name from public display as much as possible. However, in the daily interactions most employees in the facility still use and see the patient's name or identity. The need for the patient's identity is principally driven by the positive identification required to dispense services to specific individuals and provide proper billing assignments. Accordingly, herethereto, there has been no practical solution to providing positive identification while maintaining the protection of the patient's identity or privacy information.

Therefore, there has been a long standing need in the community for systems and methods which provide a limited “identity” to the attendant or sponsors of an institutionalized person, while maintaining the overall privacy of the person's identity and/or information that may be sensitive.

### SUMMARY OF THE INVENTION

The foregoing needs are met, to a great extent, by the present invention, wherein in one aspect an apparatus is provided that in some embodiments generates a pseudo-name for identification. The pseudo-name is unique to the individual and by incorporation with a locator system, such as an RFID system, access rights and privileges to the protected person's identity and information can be controlled. Through the use of proximity detection and access rights associated to a designated individual, for example, a doctor, nurse, etc., the locator system, in concert with linked devices, can dynamically regulate the level of information made available to the designated individuals.

In accordance with one embodiment of the present invention a personnel identity protection system is provided comprising, a wearable wireless communication tag having a pseudo-name identifier correlated to a protected identity of the wearer of the tag, wherein the pseudo-name does not visibly reveal the public identity or private information relating to the wearer, a transceiver capable of receiving wireless communication from the tag and capable of transmitting a signal having at least one of the tag's communication and a transceiver's location, and capable of receiving a non-tag generated signal, a computer capable of receiving the transceiver's transmitted signal and capable of initiating a non-tag signal to be transmitted to the transceiver, and software operating on the computer, the software evaluating received transceiver transmitted signals and designating the transceiver's access to differing levels of information relating to the wearer of the tag based on at least one of the transceiver's location and the tag's communication.

In accordance with another embodiment of the present invention, personnel identity protection system is provided, comprising, communication means for portably and wirelessly communicating information that is usable to identify a location of a wearer of the communication means, the communication means having a pseudo-name identifier correlated to a protected identity of the wearer of the communication means, wherein the pseudo-name does not visibly reveal the public identity or private information relating to the wearer, transceiver means for receiving wireless communication from the communication means and transmitting a signal having at least one of the wireless communication means' communication and a transceiver means' location, and capable of receiving a non-communication means generated signal, processing means for receiving the transceiver means' transmitted signal and initiating a non-communication means generated signal to be transmitted to the transceiver means, and instruction means for operating on the processing means and evaluating the received transceiver means' signals, the instruction means designating the transceiver means' access to differing levels of information relating to the wearer of the communication means based on at least one of the transceiver means' location and the communication means' communication.

In accordance with yet another embodiment of the present invention, a method for protecting identifying information of personnel is provided, comprising the steps of generating a visible pseudo-name on a wearable and wireless communication tag, the pseudo-name being correlated to a protected identity of a wearer of the tag, wherein the pseudo-name does not visibly reveal the public identity or private information relating to the wearer, transmitting a wireless communication from the tag, receiving at a transceiver at least one of the wireless communication from the tag and a non-tag generated signal, transmitting from the transceiver a signal having at least one of the tag's communication and a transceiver's location, receiving the transceiver's signal for processing by a computer, executing software instructions based on at least one of the tag's communication and the transceiver's location, designating the transceiver's access to differing levels of information relating to the wearer of the tag based on at least one of the transceiver's location and the tag's communication, and initiating a non-tag signal to be transmitted by the computer to the transceiver facilitating access to designated information relating to the wearer of the tag.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is an illustration of an exemplary embodiment.

FIG. 2 is an illustration of an implementation of an exemplary embodiment.

FIG. 3 is a flow chart illustrating an exemplary process.

### DETAILED DESCRIPTION

The invention will now be described with reference to the drawing figures, in which like reference numerals refer to like parts throughout. Patient identity theft is a growing concern within institutions, particularly the hospital community. Identity theft can occur from staff members having open access to patients' medical records. Additionally, patients have been known to steal the identities of other patients simply by looking at their medical clipboard or at their medical wristband. In particular, information such as the patient's full name and social security number is commonly imprinted on the patient's wristband, which is discernable to the public. With access to the patient's full name and social security number, identity thieves can exploit this information for nefarious purposes. Additionally, with the advent of public databases and Internet-accessible information, a person or individual may not wish to have his or her identity readily available to a wandering eye. Patients who are public figures or otherwise, for example, may be wary of having their identity revealed or be subject to stalking because of the information revealed through their name.

Accordingly, a mechanism for protecting the identity and/or social security number of patients is necessary and yet provide some distinguishing identifier to the patients for proper treatment. As such, systems and methods are described in this invention which provide personal identity and/or information protection by affording different levels of access to individuals. However, in order to enable some degree of identification of the protected person, a pseudo-name(s) is generated and assigned to the protected person.

The pseudo-name is indicated on personal device, such as a badge or wristband, for easy viewability by attending personnel. The pseudo-name is unique to the individual and may include a first name suffixed with numbers or alphanumeric characters. The pseudo-name can be entirely derived from an algorithm or portions of the pseudo-name can be derived from an algorithm based on a proprietary scheme using 16 bit Unicode characters. For example, using the last name of the individual, an eight word 16 bit Unicode format based on the first eight characters of the individual's last name can be created. If there are not enough characters to completely represent the individual's last name or if there is a duplication of names, a random number function can be utilized to generate a character. A random number function, for example, using a fractional value, provides a value 0 to 1, wherein the random number is multiplied by 26 and rounded to the nearest whole number plus ASCII value and translated to a 16 bit Unicode value. Of course, more or less than eight 16 bit Unicode characters may be used according to design preference as well as a non-English character set.

In another exemplary pseudo-name generating scheme, the social security number can be similarly converted to 16 bit unit code based pseudo-name. Combinations of the above pseudo-name generating methods can result in a hybrid pseudo-name having a first character based on the individual's first letter of his last name plus the first number of his social security number. Subsequent pseudo-name characters can be generated by progressively moving through the individual's last name and social number in sequential order. That is, for example, the second character of the pseudo-name can be based on the individual's second character of his last name and the second number of his social security number.

Alternative schemes for generating pseudo-names can be developed based on proprietary schemes that are known in the art or are future-derived in the art. Additionally, non-proprietary identification schemes may be used to effect a similar result using, for example, a Global Universal Identifier (GUID) which is generated on any PC machine that has a Media Access Control (MAC) address, available via a network card/address. This unique 128 bit identifier is generally considered globally unique. This will allow the pseudo-name to be based on a proven unique identifier scheme. Examples of systems and methods based on a pseudo-name paradigm are further detailed below.

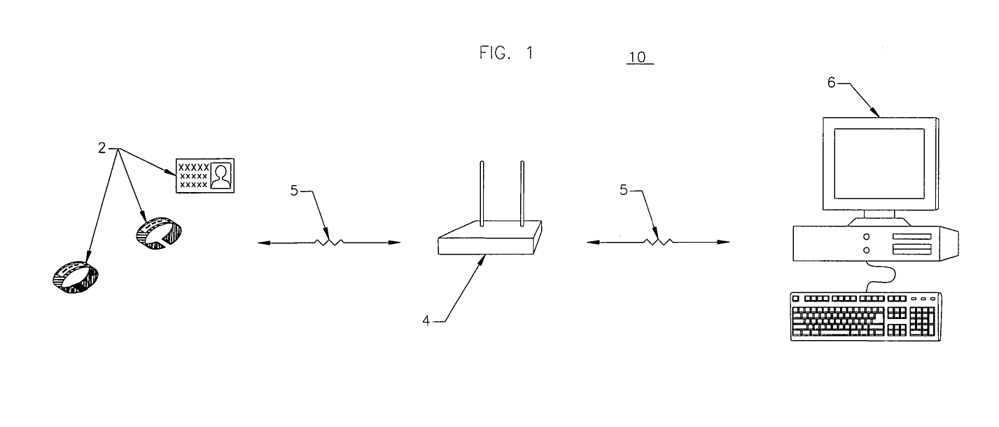

FIG. 1 is an illustration 10 of an exemplary embodiment of the present inventive apparatus and method. FIG. 1 illustrates at least one or more portable identification tags 2 which may be in the form of a badge, a wrist band, clip, card, pin, etc., device that contains passive radio frequency identification (RFID) technology. The RFID tag 2 is in communication, via radio frequency signals 5 to a RFID transceiver 4. The RFID transceiver 4 is also in communication via wireless or non-wireless connection 5 to a computer-enabled system 6. The exemplary RFD tags 2 are worn by patients and/or personnel within an operating environment such as, for example, a hospital, clinic, or institutional setting. Additionally, the RFID tags 2 may be attached to equipment within the operating environment to enable the tracking and identity of equipment.

While FIG. 1 illustrates a single transceiver 4, multiple transceivers 4 may be placed in various locations with respect to the tags 2, according to the capabilities of the RFID tag/transceiver range and operating environment. Also, the computer system 6 may be a personal computer or portable computing device or a server or any computer system capable of containing and accessing via appropriate interface information regarding the physical aspects of the environment such as room layouts, floors, identification of each transceiver 4 and its respective location, identification of each RFID tag 2 and the object or person associated with each tag 2. The computer system 6 may be connected to other computers or systems (not shown) containing databases or information relating to the location and associated information therein.

The use of RFID technology in the exemplary embodiment of FIG. 1 provides a highly cost effective, rugged and reliable solution along with the existing infrastructure data and record management system of an institution. A patient or institutionalized person would receive a badge, wristband, etc. device that would contain a passive RFID tag 2. At the time of admission or registration into the institution's system, the badge's RFID tag 2 would be programmed with a unique pseudo-name.

The tag 2 would have a unique ID stored or loaded on it referred to as a pseudo-name, and this pseudo-name would be uniquely linked to the patient's main records in the ADT or medical enterprise system. The uniqueness of the pseudo-name could be relegated to this facility's system or could be used by multiple facilities medical systems in a networked fashion. Additionally, the badge could display a nametag like name on it for use in day-to-day interfacing i.e. a person's first name and some additional alphanumeric characters or a nickname, if preferred.

A retrieval device, such as the transceiver 4, can be based on RF, IR or some other wireless technology that is compatible to the communication technology of the tag 2, to retrieve the information from this tag 2. The tag 2 could be active (self-powered) so that it could transmit the information when interrogated or passive (non-self-powered) in which case the transceiver 4 can provide the tag 2 power through, for example, inductive coupling and/or interrogate it to enable it to send its data. For security, the data exchange may be encrypted, if necessary. The pseudo-name, having no publicly recognizable identity association, would not necessarily require such encoding. The retrieval device may be a mobile device or located at a physical location. The retrieval device may have an independent retrieving capability using a built-in RFID transceiver and therefore can be a wireless PC tablet, PDA, etc. These retrieving devices can then obtain the patient's pseudo-name and thereupon retrieve with their access rights the patient associated information to allow treatment updates, condition status updates, review test results, order test results, order medication, etc. from the computer system 6 (e.g., main ADT or enterprise system).

Access control can be managed by the ADT or enterprise system, or through the specific retrieval device being utilized. Regardless of which scheme is used, only “permitted” information is disseminated to the requesting party based on an access control scheme. For example, a form on a PDA would only populate the allowed fields for the granted access rights. In turn, certain types of records would automatically be off-limits and certain functions would also be controlled through the normal IT system database access protection mechanism or retrieval device software. The ADT or enterprise system information retrieval system could be configured with an 802.11 a/b/g RF IP LAN access point or wired IP LAN connection.

It should be appreciated that the transceiver 4 would have the capability to receive the RFID tag's 2 signals and operate similar to but not necessarily as a retriever unit. The transceiver 4 can be standalone with a USB interface connection to Desktop PCs or it could be incorporated into a PC Tablet, PDA, wireless phone, etc. for mobile use. The transceiver 4 may act independent of retriever units and act as a bridge between the RFID tag 2 and another retriever unit or transceiver 4. That is, the transceiver 4 may be a fixed device that provides a communication channel for the retriever unit to the computer system 6, such as, for example, the ADT or enterprise system. If a retriever unit is an information display system, then a attending person, when interfacing with a patient to dispense services, can identify the patient by retrieving his pseudo-name and use the retriever unit to retrieve information out of the medical record system or other associated systems.

It should be appreciated that the retriever unit, with or without transceiver capabilities, can be incorporated into a patient station, pillowspeaker, patient bed or a remote station such as bath, staff, etc. to enable interfacing with a nurse call system. The nurse call system can be used to retrieve the pseudo-name, if necessary. If the staff wears RFID badges, the system could associate the patient and staff for time management use.

A simple PC software application can be used to administer and program the badges and provide an interface to the ADT or medical record system. One such system may be a HL7 gateway application by Dukane Communication Systems that interfaces to standard ADT systems using the HL7 protocol. The PC application used may be client-server based or browser based and the system operation can be agnostic to platform choice. The back-end technologies for database management, networking and software application may entirely be generic and platform independent. The existing medical record and database systems would be used and interfaced to at appropriate levels. Also existing IP LAN networks could be used for the data exchanges with medical records. The IP LANs could be a combination of RF based and wired based implementations.

Although the various implementations described herein are in the context of RFID technology using passive modes of operation, RFID badges using active (self-powered) modes (e.g., without inductive coupling) may be used. In addition, other IR, RF or ultrasonic implementations could be constructed for the badges and retriever implementations.

It should be appreciated that barcode readers can be integrated into PDA devices such as Symbol Technology's PDA readers. Therefore, other capabilities beside RFID reading or information downloading/uploading may be considered, according to design preference. For example, Magnetic cards, magnetic card readers for access and security control may be implemented. Proximity devices using passive RFID in badges for access and security control in conjunction with user privilege access screening system may also be used.

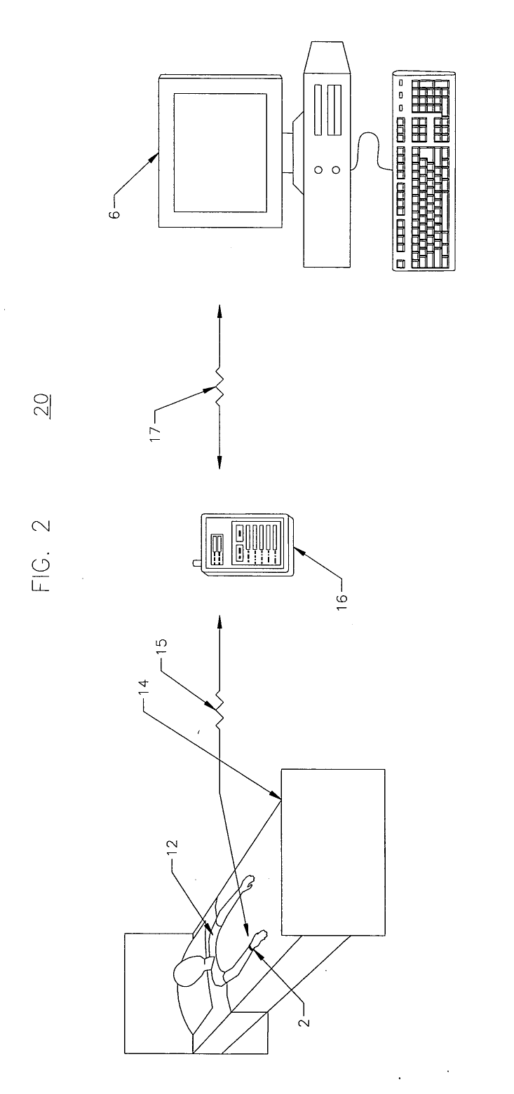

FIG. 2 illustrates an exemplary embodiment of the invention, wherein a person, for example, a patient 12 interned at a hospital, is fitted with a wristband or badge 2 having an RFID capability. The RFID badge 2 periodically or a periodically transmits a signal 15 which is received by an information device 16 and is configured in any one or more of the RFID/pseudo-name systems described herein. The information device 16 is capable of accessing information from the central computer 6 via wireless communication 17. The wireless communication 17 may also communicate with a non-central computer but with another computer system or database managing system (not shown) or transceiver 4, according to design preference.

The exemplary device 16 may operate as an electronic clipboard personnel digital assistant (PDA), laptop, or other suitable device having a electronic data processing or information disseminating properties. The electronic device 16 may also incorporate access restriction feature such as password entry, biometrics, etc. Additionally, the device 16 may also facilitate access by the sensing of the proximity of a staff or hospital member to the device 16. Alternatively, or in conjunction with the proximity attribute, the device 16 may utilize a combination proximity and RFD identifier/code that is associated with an RFID tag worn by a staff or hospital member. Accordingly, such a RFID proximity/code paradigm will obviate the inherent delay associated with manual entry-based security procedures.

For example, an attending nurse may have an RFID badge enabling her to have access to limited medical records that are germane to her functions in attending to the patient 12. In contrast, a physician having an RFID badge will be have increased access privileges and may have access to the entire patient 12 medical records. As is apparent, one of ordinary skill in the art having understood the description of the invention described herein, may tier the access privileges and scope of the information available to various hospital personnel, as deemed appropriate. For example, a billing specialist may only have access to the cost associated with treating the patient 12.

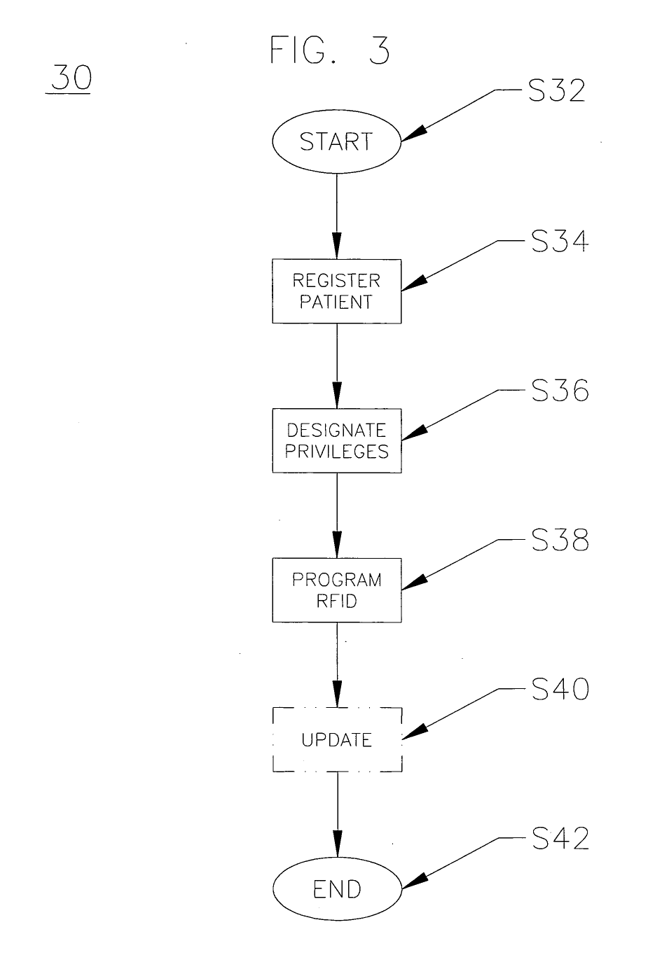

FIG. 3 is a flow chart 30 illustrating an exemplary process. The exemplary process 30 begins at the start step S32. From the start step S32, a patient entering an institution, such as a hospital or medical facility, is registered with the hospital or medical facility at step S34. Registration of the patient can include the patient's full name, insurance policy (if available), social security number, medical history, current address and other information that is commonly used in registering a patient for treatment. After completion of step S34, information gathered from the patient is categorized according to sensitivity and access privileges and is designated on a need-to-know basis as shown in step S36. From step S36, the exemplary process 30 proceeds to the next step S38 of programming the RFID badges or bracelets 2. The programming step S38 generates a pseudo-name that is assigned to the patient for future identification, in accordance to any of the pseudo-name schemes described herein, or any other scheme that provides similar functionalities.

From step S38 the exemplary process 30 optionally proceeds to step S40 which updates databases of computer systems that control access to the patient's information, for such information that was not already updated or loaded in steps s34, s36, and s38. Alternatively, security designations or area privileges may be loaded into the tag 2 such that the patient is restricted with respect to areas in the institution that he may visit. Likewise, locator sensors or transceivers within the institution may alerted to “wandering” rights of the patient. From optional step S40, the exemplary process 30 arrives at step s42 for completion of the exemplary process 30.

Based on the above disclosure, combinations of the various pseudo-name methods or processes may be employed without departing from the spirit and scope of this invention. Accordingly, a patient may have a pseudo-name based on his actual first name and pseudo-name generated last name. Of course, while the above pseudo-name generation schemes are couched in the context of a last name and a social security number, other names, such as, for example, nicknames, middle names, maiden names, may be used. Additionally, telephone numbers, medical record ID number, PIN numbers or any other combination thereof may be used to also generate a pseudo-name to help identify the patient.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A personnel identity protection system, comprising:
a wearable wireless communication tag having a pseudo-name identifier correlated to a protected identity of the wearer of the tag, wherein the pseudo-name does not visibly reveal the public identity or private information relating to the wearer;
a transceiver capable of receiving wireless communication from the tag and capable of transmitting a signal having at least one of the tag's communication and a transceiver's location, and capable of receiving a non-tag generated signal;
a computer capable of receiving the transceiver's transmitted signal and capable of initiating a non-tag signal to be transmitted to the transceiver; and
software operating on the computer, the software evaluating received transceiver transmitted signals and designating the transceiver's access to differing levels of information relating to the wearer of the tag based on at least one of the transceiver's location and the tag's communication.

2. The personnel identity protection system of claim 1, wherein the tag is a badge.

3. The personnel identity protection system of claim 1, wherein the tag is a wristband.

4. The personnel identity protection system of claim 1, wherein the software is operating on the transceiver.

5. The personnel identity protection system of claim 1, wherein the transceiver is a portable platform having an information display.

6. The personnel identity protection system of claim 1, wherein the transceiver is a personal digital assistant.

7. The personnel identity protection system of claim 1, wherein the transceiver is a computer.

8. The personnel identity protection system of claim 1, wherein the transceiver communicates wirelessly to the computer.

9. The personnel identity protection system of claim 1, wherein the pseudo-name contains at least only one of the surname or first name of the wearer of the tag.

10. The personnel identity protection system of claim 1, wherein at least one or more characters in the pseudo-name is randomly generated from a Unicode character.

11. The personnel identity protection system of claim 1, wherein the transceiver's access to differing levels of information relating to the wearer of the tag is based on an access code input into the transceiver.

12. The personnel identity protection system of claim 1, wherein the differing levels of information includes medical information of the wearer of the tag.

13. The personnel identity protection system of claim 1, wherein the differing levels of information includes the public identity of the wearer of the tag.

14. The personnel identity protection system of claim 1, further comprising:
a non-psuedo-name wireless communication tag, the non-psuedo-name tag communicates at least one of a location and identity of a wearer of the non-psuedo-name tag.

15. The personnel identity protection system of claim 14, wherein the non-psuedo-name tag is in communication with at least one of the transceiver and the computer.

16. The personnel identity protection system of claim 14, wherein the non-pseudo-name tag communicates at least one of a location and an access privilege of the wearer of the non-psuedo-name tag.

17. The personnel identity protection system of claim 14, wherein the non-psuedo-name tag wearer is a medically-related professional.

18. The personnel identity protection system of claim 14, wherein the transceiver's access to differing levels of information relating to the wearer of the tag is based on at least one of a proximity of the non-psuedo-name wearer to the location of the transceiver and an identity of the non-psuedo-name wearer.

19. A personnel identity protection system, comprising:
communication means for portably and wirelessly communicating information that is usable to identify a location of a wearer of the communication means, the communication means having a pseudo-name identifier correlated to a protected identity of the wearer of the communication means, wherein the pseudo-name does not visibly reveal the public identity or private information relating to the wearer;
transceiver means for receiving wireless communication from the communication means and transmitting a signal having at least one of the wireless communication means' communication and a transceiver means' location, and capable of receiving a non-communication means generated signal;
processing means for receiving the transceiver means' transmitted signal and initiating a non-communication means generated signal to be transmitted to the transceiver means; and
instruction means for operating on the processing means and evaluating the received transceiver means' signals, the instruction means designating the transceiver means' access to differing levels of information relating to the wearer of the communication means based on at least one of the transceiver means' location and the communication means' communication.

20. A method for protecting identifying information of personnel, comprising the steps of:
generating a visible pseudo-name on a wearable and wireless communication tag, the pseudo-name being correlated to a protected identity of a wearer of the tag, wherein the pseudo-name does not visibly reveal the public identity or private information relating to the wearer;
transmitting a wireless communication from the tag;
receiving at a transceiver at least one of the wireless communication from the tag and a non-tag generated signal;
transmitting from the transceiver a signal having at least one of the tag's communication and a transceiver's location;
receiving the transceiver's signal for processing by a computer;
executing software instructions based on at least one of the tag's communication and the transceiver's location;
designating the transceiver's access to differing levels of information relating to the wearer of the tag based on at least one of the transceiver's location and the tag's communication; and
initiating a non-tag signal to be transmitted by the computer to the transceiver facilitating access to designated information relating to the wearer of the tag.

21. The method of claim 20, further comprising the step of:
designating access to the differing levels of information based on a transceiver user's privilege.

22. The method of claim 20, wherein the step of executing software instructions is performed by the transceiver.

23. The method of claim 20, wherein step of generating a pseudo-name is accomplished by randomly generating one or more characters in the pseudo-name using a Unicode character.

24. The method of claim 20, wherein step of designating the transceiver's access is based on an access code input into the transceiver.

25. The method of claim 20, further comprising the step of:
communicating at least one of a location and identity of a wearer of a non-psuedo-name tag to at least one of the transceiver and a computing platform executing the instructions.

26. The method of claim 25, wherein the transceiver's access to differing levels of information relating to the wearer of the tag is based on at least one of a proximity of the non-psuedo-name tag wearer to the location of the transceiver and an identity of the non-psuedo-name wearer.
